(19) United States
(12) Patent Application Publication
(10) Pub. No.: US 2008/0055375 A1
(43) Pub. Date: Mar. 6, 2008

(54) INKJET, FLUID EJECTION DEVICE , AND PRESSURE CONTROL METHOD THEREOF

(75) Inventors: Shun-Chuan Lin, Hsinchi (TW); May-Chi Ho, Taoyuan County (TW); Wei-Liang Hsu, Taipei City (TW); Po-Fu Chou, Taoyuan County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/625,780

(22) Filed: Jan. 22, 2007

(30) Foreign Application Priority Data
Sep. 5, 2006 (TW) TW95132714

(51) Int. Cl. B41J 2/175

(52) U.S. Cl. 347/86

(57) ABSTRACT

An inkjet comprises a chamber and a pressure control unit. The pressure control unit is connected to the chamber. The pressure control unit comprises an inlet, an outlet, an elastic mechanism, and seal block. The seal block is connected to the elastic mechanism, which moves the seal block between a first position and a second position via an elastic force. When the seal block is in the first position the seal block seals the inlet. When the seal block is in the second position, airflow passes the inlet, the pressure control unit, and the outlet into the chamber.

### BACKGROUND OF THE INVENTION

1. Field of the Invention

The invention relates to an inkjet, and in particular to a highly reliable inkjet.

2. Description of the Related Art

FIG. 1 shows a conventional inkjet 1 as disclosed in U.S. Pat. No. 6,213,598, comprising a bladder 10, a plate 20, a spring 30, an elastic sheet 40 and ball 50. Airflows into the bladder 10 via a through hole 11 to inflate the bladder 10, and the spring 30 is compressed. When the plate 20 contacts the elastic sheet 40, negative pressure in the inkjet 1 reaches a predetermined pressure, atmospheric pressure pushes the ball 50 via inlet 51, airflows into the inkjet 1, and negative pressure therein decreases. As negative pressure decreases, the bladder 10 contracts, and spring 30 pushes the elastic sheet 40 to move the ball 50 back. Throughout, pressure in the inkjet 1 remains within a fixed pressure range.

The conventional inkjet as disclosed is difficult to assemble. The inner space of the inkjet 1 restricts expansion of the bladder 10 and the pressure range therein. Additionally, number of required elements is high, and the material of bladder 10 can deteriorate with time, affecting reliability of the conventional inkjet.

### BRIEF SUMMARY OF THE INVENTION

A detailed description is given in the following embodiments with reference to the accompanying drawings.

An inkjet comprises a chamber and a pressure control unit. The pressure control unit is connected to the chamber. The pressure control unit comprises an inlet, an outlet, an elastic mechanism and seal block. The seal block is connected to the elastic mechanism, which moves the seal block between a first position and a second position via elastic force. The seal block, when in the first position, seals the inlet. When in the second position, airflow passes the inlet, the pressure control unit, and the outlet into the chamber.

In the invention, the predetermined pressure is controlled by the weight of the seal block, the elastic factor of the elastic mechanism or the section area of the inlet, to prevent fluid (ink) from leakage out of nozzle. Fewer elements are required, such that the inkjet is easier assembled, with improved reliability.

### BRIEF DESCRIPTION OF THE DRAWINGS

The invention can be more fully understood by reading the subsequent detailed description and examples with references made to the accompanying drawings, wherein:

FIG. 1 shows a conventional inkjet;

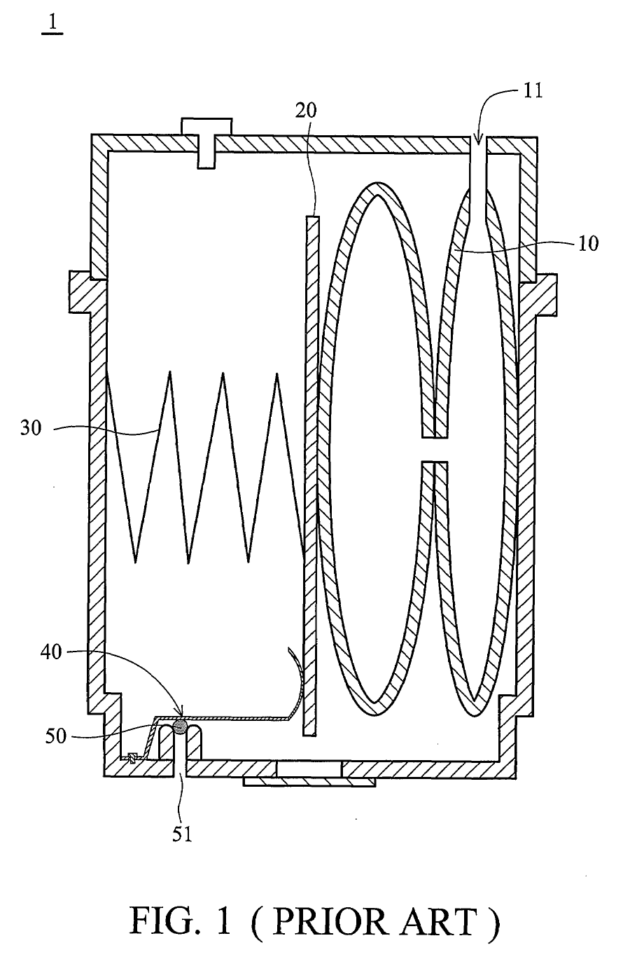

FIG. 2a shows an inkjet of a first embodiment of the invention, wherein a seal block is in a first position;

FIG. 2b shows an inkjet of a first embodiment of the invention, wherein a seal block is in a second position;

FIGS. 3a and 3b show a detailed structure of an inlet;

FIG. 4 shows a detailed structure of a housing;

FIG. 5 shows a modified example of the first embodiment;

FIG. 6a shows an inkjet of a second embodiment of the invention, wherein a seal block is in a first position; and

FIG. 6b shows an inkjet of a second embodiment of the invention, wherein a seal block is in a second position.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

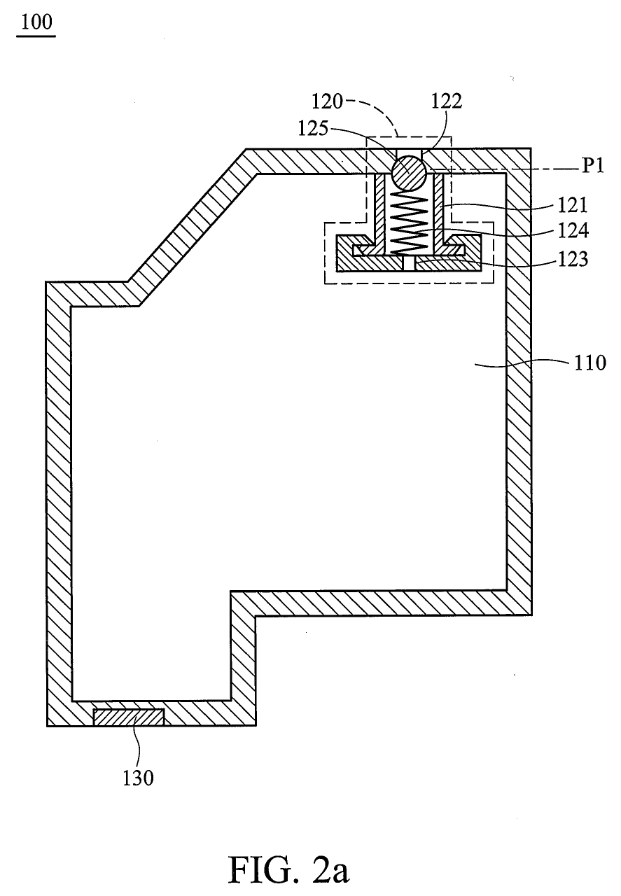

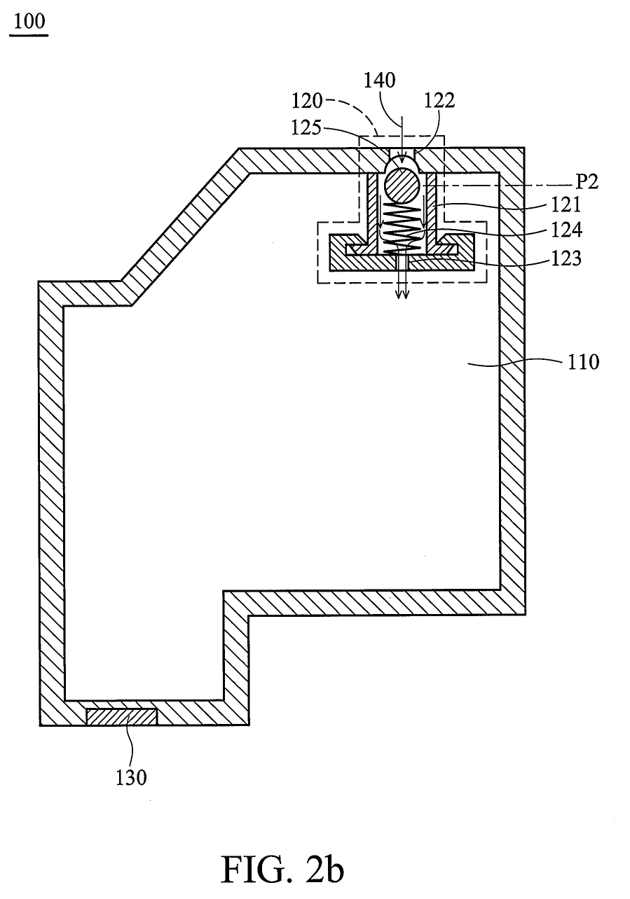

FIGS. 2a and 2b show an inkjet 100 of a first embodiment of the invention, comprising a chamber 110, a pressure control unit 120 and a nozzle 130. The pressure control unit 120 is disposed in the chamber 110 and connected thereto. The pressure control unit 120 comprises a housing 121, an inlet 122, outlet 123, an elastic mechanism 124, and a seal block 125. The inlet 122 is formed on a surface of the chamber 110. The outlet 123 is formed on a surface of the housing 121. The seal block 125 is connected to the elastic mechanism 124. The elastic mechanism 124 abuts the housing 121. The elastic mechanism 124 moves the seal block 125 between a first position P1 (as shown in FIG. 2a) and a second position P2 (as shown in FIG. 2b) by elastic force. As shown in FIG. 2a, when the seal block 125 is in the first position P1, the seal block 125 seals the inlet 122. As shown in FIG. 2b, when the seal block 125 is in the second position P2, airflow 140 passes the inlet 122, the pressure control unit 120, and the outlet 123 into the chamber 110. The nozzle 130 is disposed on the chamber 110.

The chamber 110 is a fluid container. After the inkjet 100 ejects ink, a negative pressure in the chamber 110 exceeds a predetermined pressure, and atmospheric pressure moves the seal block from the first position P1 to the second position P2. After the airflow 140 enters the chamber 110, the negative pressure in the chamber 110 decreases, and the elastic mechanism 124 returns the seal block 125 to the first position P1 by elastic force. Thus, the pressure control unit 120 of the invention controls the negative pressure in the chamber 110 to prevent leakage.

In the first embodiment, the inlet 122, the elastic mechanism 124 and the seal block 125 are aligned in a vertical direction. The seal block 125 is located between inlet 122 and the elastic mechanism 124. The seal block 125 is a ball. The elastic mechanism 124 is a spring.

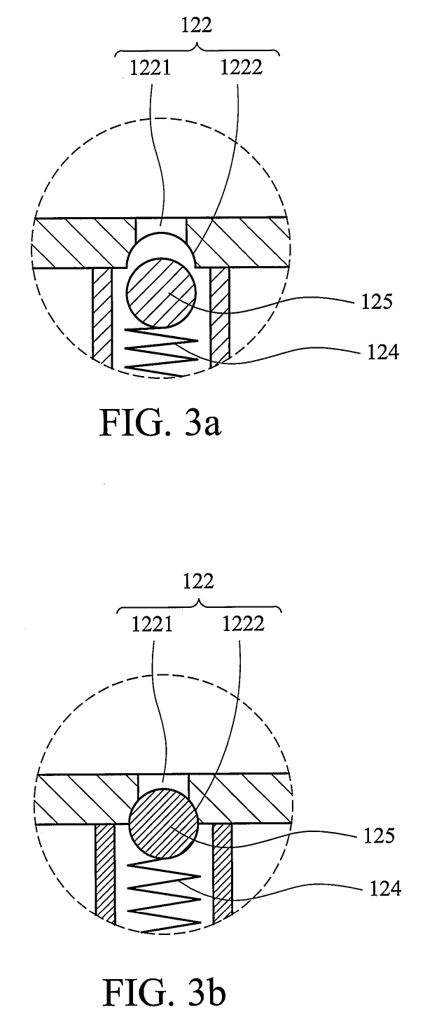

FIG. 3a shows a detailed structure of the inlet 122, comprising an inlet path 1221 and a recess 1222. The shape of the recess 1222 corresponds to the shape of the seal block 125. When the seal block 125 is in the first position (as shown in FIG. 3b), the seal block 125 sufficiently contacts the recess 1222, and seals the inlet 122. In the first embodiment, the curvature of the recess 1222 is the same as the curvature of the seal block 125, and the center of curvature of the recess 1222 and the center of curvature of the seal block 125 are on a vertical line. The contact area between the recess 1222 and the seal block 125 is less than half the surface area of the seal block 125.

In the embodiment of the invention, the predetermined pressure is between −5 and −15 mini bars.

The predetermined pressure is controlled by the weight of the seal block 125, the elastic factor of the elastic mechanism 124 or the section area of the inlet 122. When the elastic factor of the elastic mechanism 124 increases, the predetermined pressure increases. When the elastic factor of the elastic mechanism 124 decreases, the predetermined pressure decreases. When the weight of the seal block 125 increases, the predetermined pressure increases. When the weight of the seal block 125 decreases, the predetermined pressure decreases. When the section area of the inlet 122 increases, the contact area between the seal block 125 and atmosphere increases, and the predetermined pressure increases. When the section area of the inlet 122 decreases, the contact area between the seal block 125 and atmosphere decreases, and the predetermined pressure decreases.

Thus, the predetermined pressure is controlled by the weight of the seal block 125, the elastic factor of the elastic mechanism 124 or the section area of the inlet 122 to prevent leakage from nozzle 130. In the embodiment of the invention, the elastic factor of the elastic mechanism 124 is 0.5. The element number of the inkjet of the invention decreases. The inkjet of the invention is thus easier assembled, and provides improved reliability.

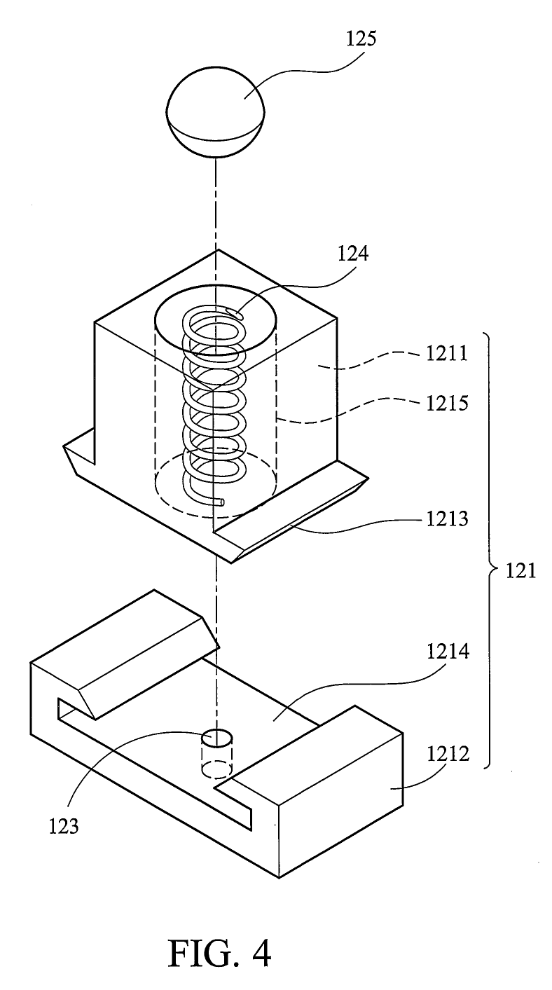

FIG. 4 shows a detailed structure of the housing 121, comprising a body 1211 and a base 1212. The body 1211 comprises a tenon 1213 formed on a bottom thereof, and the body 1211 wedges the base 1212 by the tenon 1213. The elastic mechanism 124 is supported by a surface 1214 of the base 1212. The elastic mechanism 124 and the seal block 125 are disposed in a through hole 1215 of the body 1211. The diameter of the seal block 125 exceeds the diameter of the elastic mechanism 124. The diameter of the through hole 1215 exceeds the diameter of the seal block 125. The body 1211 and the base 1212 are formed by injection molding.

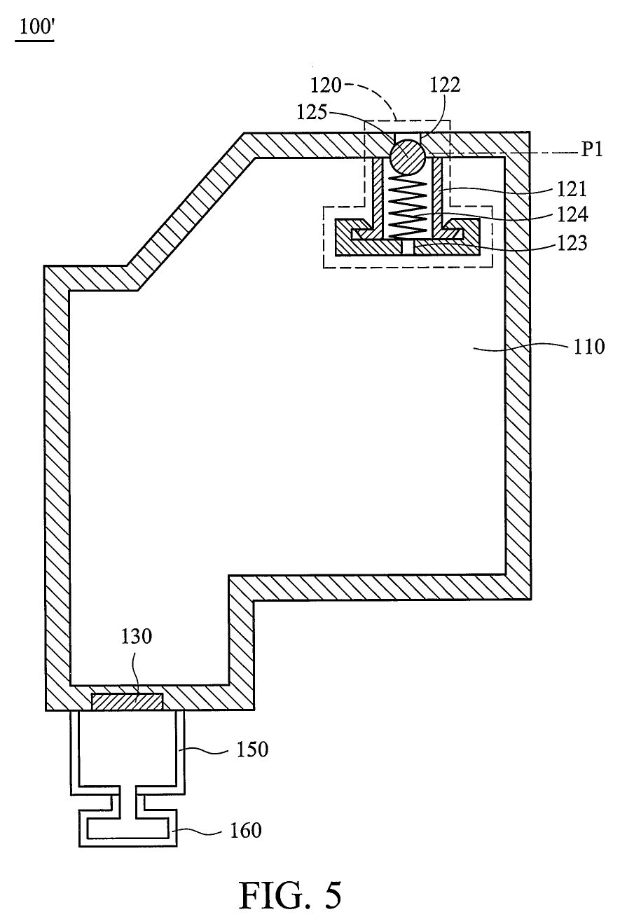

FIG. 5 shows a modified embodiment of the first embodiment of the invention, a medicine producer 100′. The medicine producer 100′ further comprises a dryer 150 and a collector 160. Medicinal fluid is contained in the chamber 110, ejected by the nozzle 130, dried by the dryer 150 to powder, and the powder is collected by the collector 160.

The pressure control unit of the invention can be utilized in any fluid ejection device.

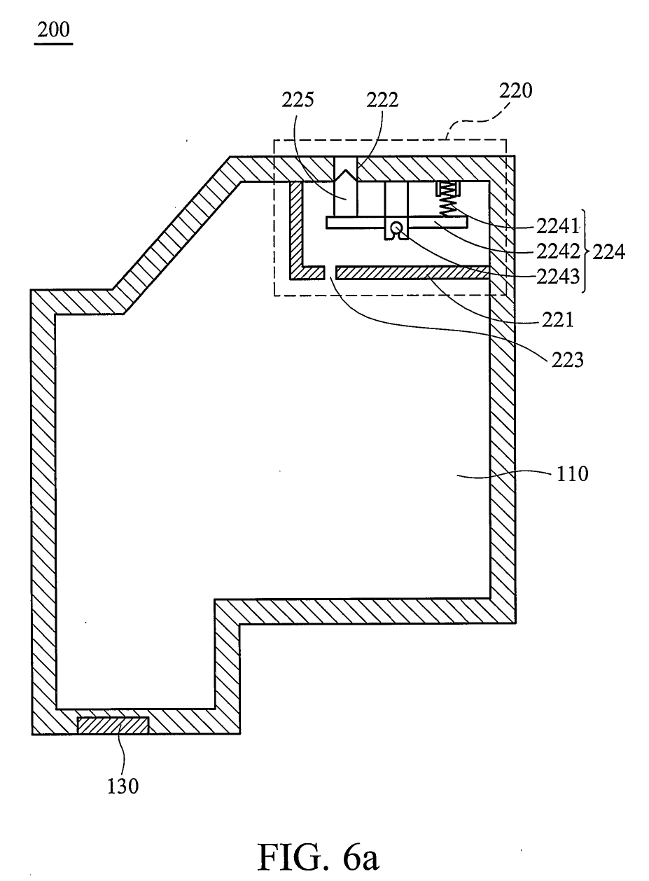

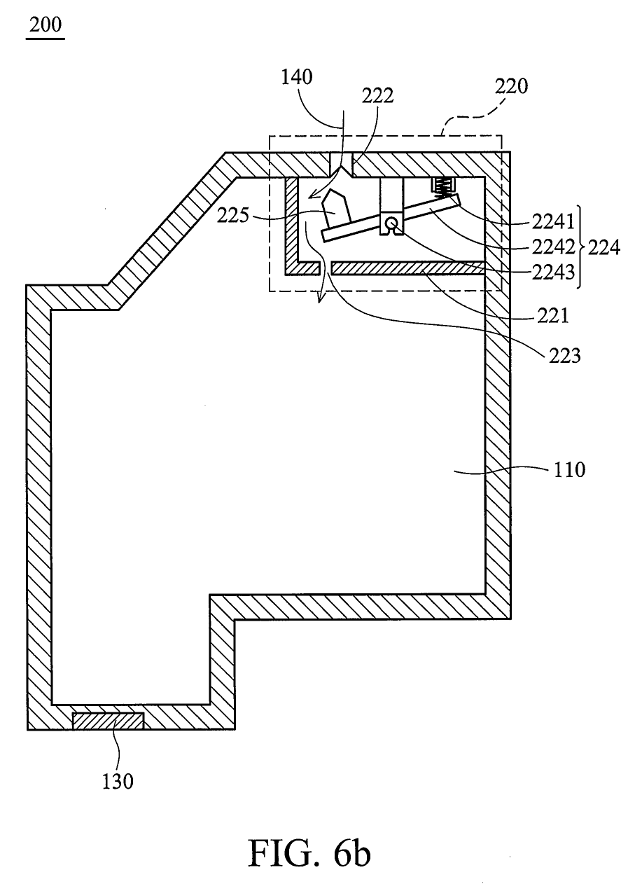

FIGS. 6a and 6b show an inkjet 200 of a second embodiment of the invention, comprising a chamber 110, a pressure control unit 220 and a nozzle 130. The pressure control unit 220 is disposed in the chamber 110 and connected thereto. The pressure control unit 220 comprises a housing 221, an inlet 222, an outlet 223, an elastic mechanism 224 and a seal block 225. In the second embodiment, the elastic mechanism 224 comprises a spring 2241, a rod 2242 and a fulcrum 2243. The rod 2242 pivots on the fulcrum 2243 in the housing 221. The spring 2241 is connected to an end of the rod 2242, and the seal block 225 is connected to another end of the rod 2242. When the seal block 225 is in the first position (as shown in FIG. 6a) sealing the inlet 222, the rod 2242 is in a first orientation. When the seal block 225 is in the second position (as shown in FIG. 6b), the inlet 222 is opened, the rod 2242 is in a second orientation, and the spring 2241 applies an elastic force over the rod 2242.

In the second embodiment, the top portion of the seal block 225 is conical, and the shape of a lower portion of the inlet 222 corresponds thereto.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An inkjet, comprising:
a chamber; and
a pressure control unit, connected to the chamber, wherein the pressure control unit comprises an inlet, an outlet, an elastic mechanism and seal block, wherein the seal block is connected to the elastic mechanism, the elastic mechanism moves the seal block between a first position and a second position via an elastic force, and when the seal block is in the first position, the seal block seals the inlet, and when the seal block is in the second position, airflow passes the inlet, the pressure control unit, and the outlet into the chamber.

2. The inkjet as claimed in claim 1, wherein the inlet, the elastic mechanism and the seal block are aligned in a vertical direction, and the seal block is located between the inlet and the elastic mechanism.

3. The inkjet as claimed in claim 1, wherein when a negative pressure in the chamber exceeds a predetermined pressure, atmospheric pressure moves the seal block from the first position to the second position.

4. The inkjet as claimed in claim 1, wherein the predetermined pressure is between −5 and −15 mini bars.

5. The inkjet as claimed in claim 1, wherein the inlet comprises an inlet path and a recess, the recess corresponding to the seal block, and when the seal block is in the first position, the seal block contacts the recess and seals the inlet.

6. The inkjet as claimed in claim 4, wherein the seal block is a ball.

7. The inkjet as claimed in claim 4, wherein the seal block is conical.

8. The inkjet as claimed in claim 1, wherein the elastic structure is a spring, and an elastic factor thereof is 0.5.

9. The inkjet as claimed in claim 1, further comprising a nozzle, disposed on the chamber.

10. The inkjet as claimed in claim 1, wherein the chamber is a fluid container.

11. The inkjet as claimed in claim 1, wherein the elastic mechanism comprises a spring and a rod, the rod pivoting in the pressure control unit, the spring connected to an end of the rod, the seal block connected to another end of the rod, wherein when the seal block is in the first position, the rod is in a first orientation, and when the seal block is in the second position, the rod is in a second orientation pressing the spring.

12. A pressure control method, comprising:
providing the inkjet as claimed in claim 3;
controlling a weight of the seal block to control the predetermined pressure.

13. A pressure control method, comprising:
providing the inkjet as claimed in claim 3;
controlling an elastic factor of the elastic mechanism to control the predetermined pressure.

14. A pressure control method, comprising:
providing the inkjet as claimed in claim 3;
controlling a diameter of a inlet path of the inlet to control the predetermined pressure.

15. A pressure control unit, connected to a chamber, comprising:
an inlet, an outlet, an elastic mechanism and seal block, the seal block connected to the elastic mechanism, the elastic mechanism moving the seal block between a first position and a second position via an elastic force, wherein when the seal block is in the first position, the seal block seals the inlet, and when the seal block is in the second position, and airflow passes the inlet, the pressure control unit, and the outlet into the chamber.

16. A fluid ejection device, comprising:
a chamber; and
a pressure control unit, connected to the chamber, wherein the pressure control unit comprises an inlet, an outlet, an elastic mechanism and seal block, the seal block connected to the elastic mechanism, the elastic mechanism moving the seal block between a first position and a second position via an elastic force, wherein when the seal block is in the first position, the seal block seals the inlet, and when the seal block is in the second position, and airflow passes the inlet, the pressure control unit, and the outlet into the chamber.

17. The fluid ejection device as claimed in claim 16, wherein the fluid ejection device is a medicine producer.

18. The fluid ejection device as claimed in claim 16, further comprising a nozzle, a dryer and a collector, wherein the nozzle is disposed on the chamber, a medicinal fluid is contained in the chamber, ejected by the nozzle, dried by the dryer to powder, and the powder is collected by the collector.
